(19) United States
(12) Patent Application Publication
(10) Pub. No.: US 2024/0414278 A1
(43) Pub. Date: Dec. 12, 2024

(54) IMAGE READING DEVICE, IMAGE FORMING APPARATUS, AND IMAGE READING METHOD

(71) Applicants: Atsuki Nishigo, Tokyo (JP); Hironori Sasaki, Kanagawa (JP)

(72) Inventors: Atsuki Nishigo, Tokyo (JP); Hironori Sasaki, Kanagawa (JP)

(73) Assignee: Ricoh Company, Ltd., Tokyo (JP)

(21) Appl. No.: 18/678,328

(22) Filed: May 30, 2024

(30) Foreign Application Priority Data
Jun. 12, 2023 (JP) 2023-096572

(51) Int. Cl. H04N 1/401; H04N 1/407

(52) U.S. Cl. CPC H04N 1/401; H04N 1/4076; H04N 2201/0081

(57) ABSTRACT

An image reading device includes an image reader to read image data from a document; a density reference member facing the image reader; a movable mechanism to movably support the density reference member in a movable state; a lock mechanism to lock the movable mechanism to fix a position of the density reference member in a fixed state; and circuitry configured to cause the image reader to read the image data from the document while the density reference member is at a first position in the fixed state; cause the image reader to read shading data from the density reference member while the density reference member is at a second position different from the first position in the movable state; generate reference data used for a shading correction from the shading; and perform the shading correction on the image data, using the reference data.

### CROSS-REFERENCE TO RELATED APPLICATIONS

This patent application is based on and claims priority pursuant to 35 U.S.C. § 119(a) to Japanese Patent Application No. 2023-096572, filed on Jun. 12, 2023, in the Japan Patent Office, the entire disclosure of which is hereby incorporated by reference herein.

### BACKGROUND

### Technical Field

Embodiments of the present disclosure relate to an image reading device, an image forming apparatus, and an image reading method.

### Related Art

Images scanned by a scanner have periodic unevenness caused by the lens that focuses light onto the sensor. The data read from the white member positioned opposite the sensor is used as white reference data for shading correction of the images scanned by the scanner.

In order to accurately perform shading correction using a white reference plate disposed at a position different from the document reading position, a technique is disclosed that involves pre-storing shading data generated from the white reference plate. Using this shading data, whether the shading data of the white reference plate read immediately beforehand is determined. Based on the determination, an adjustment value is calculated, and shading correction is performed according to this adjustment value.

However, since the member used to generate the reference data is located on the paper conveyance path, it is in an environment where dust such as paper dust is likely to adhere. However, when noise, such as dust, is superimposed on the reference data, vertical streaks can appear in the corrected image data. When the board containing the memory for storing reference data or the reading module itself is replaced, it is necessary to regenerate the reference data outside the manufacturing environment. However, eliminating the impact of dust is challenging.

### SUMMARY

An embodiment of the present disclosure provides an image reading device including an image reader to read image data from a document; a density reference member facing the image reader; a movable mechanism to movably support the density reference member in a movable state; a lock mechanism to lock the movable mechanism to fix a position of the density reference member in a fixed state; and circuitry configured to: cause the image reader to read the image data from the document while the density reference member is at a first position in the fixed state; cause the image reader to read shading data from the density reference member while the density reference member is at a second position different from the first position in the movable state; generate reference data used for a shading correction from the shading data read from the density reference member by the image reader; and perform the shading correction on the image read from the document by the image reader, using the reference data.

An embodiment of the present disclosure provides an image reading method including reading image data from a document while a density reference member is at a first position; unlocking the density reference member facing an image reader to be movable; moving the density reference member from the first position to a second position different from the first position; reading shading data from the density reference member at the second position; generating reference data used for shading correction from the shading data read from the density reference member; and performing the shading correction on the image data read from the document, using the reference data generated from the shading data.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a hardware configuration of an image forming apparatus according to a first embodiment of the present disclosure;

FIG. 2 is a diagram of a functional configuration related to read signal processing according to the first embodiment;

FIG. 3 is a diagram illustrating a density reference member and a lock mechanism according to the first embodiment;

FIG. 4 is a diagram illustrating a configuration of components for image reading processing according to the first embodiment;

FIG. 5A is a diagram of a movable mechanism, or the fixed state, to move the density reference member of FIG. 3 in the sub-scanning direction according to the first embodiment;

FIG. 5B is a diagram of a movable mechanism, or the movable state, to move the density reference member of FIG. 3 in the sub-scanning direction according to the first embodiment;

FIG. 6 is a diagram of a movable mechanism to move the density reference member of FIG. 3 in a main scanning direction according to the first embodiment;

FIG. 7 is a flowchart of an image reading method according to the first embodiment; and

FIG. 8 is a diagram of a functional configuration for read signal processing according to a second embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to one aspect of the present disclosure, clean reference data can be generated more easily.

In the following description, an image reading device, an image forming apparatus, and an image reading method according to embodiments of the present disclosure will be described in detail with reference to the drawings.

### First Embodiment

In the first embodiment, an image forming apparatus is described as an MFP having at least two of copying, printing, scanning, and facsimile functions. Alternatively, the image forming apparatus may be a device, e.g., an image reading device having scanner function of a copier, a printer, a scanner, or a facsimile machine.

### Example of Hardware Configuration

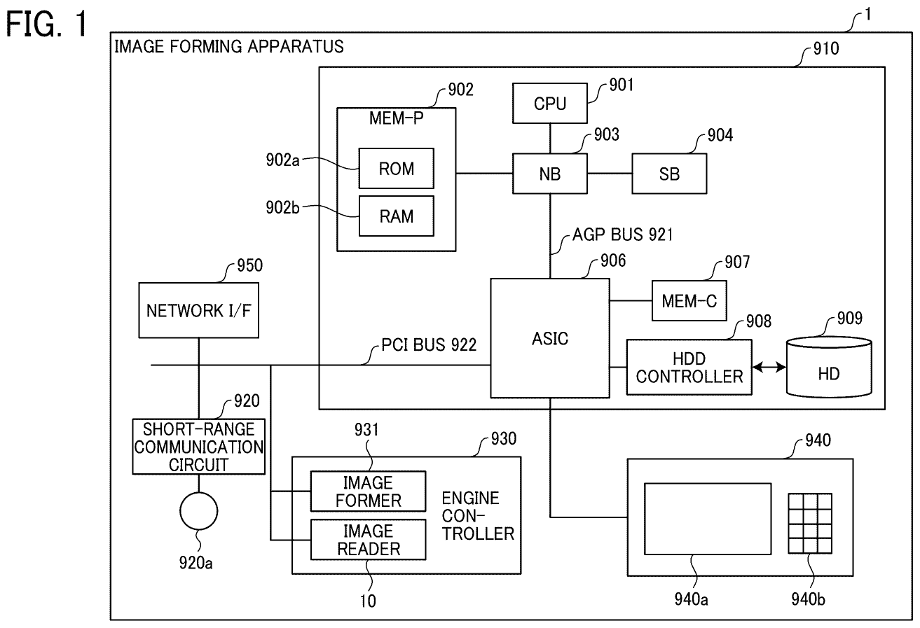

FIG. 1 is a diagram illustrating a hardware configuration of an image forming apparatus 1 according to a first embodiment of the present disclosure.

Referring to FIG. 1, a description is given of a hardware configuration of the image forming apparatus 1 according to the present embodiment. In FIG. 1, the image forming apparatus 1 is a multifunction peripheral (MFP).

As illustrated in FIG. 1, the image forming apparatus 1 includes a controller 910, a short-range communication circuit 920, an engine controller 930, a control panel 940, and a network interface (I/F) 950.

The controller 910 includes a central processing unit (CPU) 901 as a processor of a computer, a system memory (MEM-P) 902, a north bridge (NB) 903, a south bridge (SB) 904, an application-specific integrated circuit (ASIC) 906, a local memory (MEM-C) 907, a hard disk drive (HDD) controller 908, and a hard drive (HD) 909. The NB 903 and the ASIC 906 are connected through an accelerated graphics port (AGP) bus 921.

The CPU 901 is a computing device that performs overall control of the image forming apparatus 1. The NB 903 connects the CPU 901 to the MEM-P 902, the SB 904, and the AGP bus 921. The NB 903 includes a peripheral component interconnect (PCI) master, an AGP target, and a memory controller that controls the reading and writing of data from and to the MEM-P 902.

The MEM-P 902 includes a read-only memory (ROM) 902a and a random-access memory (RAM) 902b. The ROM 902a stores data and programs for implementing various functions of the controller 910. The RAM 902b is used to load the programs and the data. For example, the RAM 902b is used as a drawing memory to store drawing data for printing. The programs that are stored in the RAM 902b may be stored in a computer-readable recording medium in an installable or executable file format so that the programs can be provided. Examples of the computer-readable recording medium include, but are not limited to, a compact disc read-only memory (CD-ROM), a compact disc-recordable (CD-R), and a digital versatile disc (DVD).

The SB 904 connects the NB 903 to, for example, a PCI device and a peripheral device. The ASIC 906 is an integrated circuit (IC) dedicated to image processing and includes hardware elements for image processing. The ASIC 906 serves as a bridge to connect the AGP bus 921, a PCI bus 922, the HDD controller 908, and the MEM-C 907 to each other. The ASIC 906 includes a PCI target and an AGP master, an arbiter (ARB) that forms the core of the ASIC 906, a memory controller that controls the MEM-C 907, multiple direct memory access controllers (DMAC) that rotate image data by hardware logic, and a PCI unit that transfers data between an image reader 10 and an image former 931 via the PCI bus 922. The ASIC 906 may be connected to a universal serial bus (USB) interface or the Institute of Electrical and Electronics Engineers 1394 (IEEE1394) interface.

The MEM-C 907 is a local memory used as a copy image buffer and a code buffer. The HDD controller 908 is a controller that controls reading or writing data from or to the HD 909 based on the control of the CPU 901. The HD 909 is a storage device that accumulates image data, font data for printing, and form data. The HDD controller 908 and the HD 909 may be a solid state drive (SSD) controller and an SSD, respectively.

The AGP bus 921 is a bus interface for a graphics accelerator card, which is proposed to accelerate graphics processing. Direct access to the MEM-P 902 by high throughput can accelerate the graphics accelerator card.

The short-range communication circuit 920 is a communication circuit in compliance with a protocol such as near field communication (NFC) or BLUETOOTH. The short-range communication circuit 920 is electrically connected to the ASIC 906 through the PCI bus 922. An antenna 920a for wireless communication is connected to the short-range communication circuit 920.

The engine controller 930 includes an image reader 10 and an image former 932. The image reader 10 and the image former 931 include an image processing function such as error diffusion or gamma conversion.

The control panel 940 includes a panel display 940a (e.g., a display device) and a hard key 940b. The panel display 940a is, for example, a touch panel that displays current settings or a selection screen and receives a user input. The hard key 940b includes, for example, a numeric keypad and a start key. The numeric keypad receives assigned values of image forming parameters such as an image density parameter. The start key receives an instruction to start copying.

The image forming apparatus 1 can sequentially switch and select the document box function, the copy function, the printer function, and the fax function by the switch key of the control panel 940 to switch applications. When the document box function is selected, the image forming apparatus 10 enters a document box mode. When the copier function is selected, the image forming apparatus 10 enters a copier mode. When the printer function is selected, the image forming apparatus 10 enters a printer mode. When the facsimile function is selected, the image forming apparatus 10 enters a facsimile mode.

The network I/F 950 is an interface that enables data communication through a network. For example, the network I/F 950 enables communication in compliance with ETHERNET and Transmission Control Protocol (TCP)/Internet Protocol (IP). The network I/F 950 is electrically connected to the ASIC 906 through the PCI bus 922.

The hardware configuration of the image forming apparatus 1 is not limited to that illustrated in FIG. 1. The image forming apparatus 1 does not necessarily include all the components illustrated in FIG. 1 or may include some other components.

The following describes processing of image reading signals read by the image reader 10 in FIG. 1.

### Example of Functional Configuration Related to Processing of Image Reading Signal

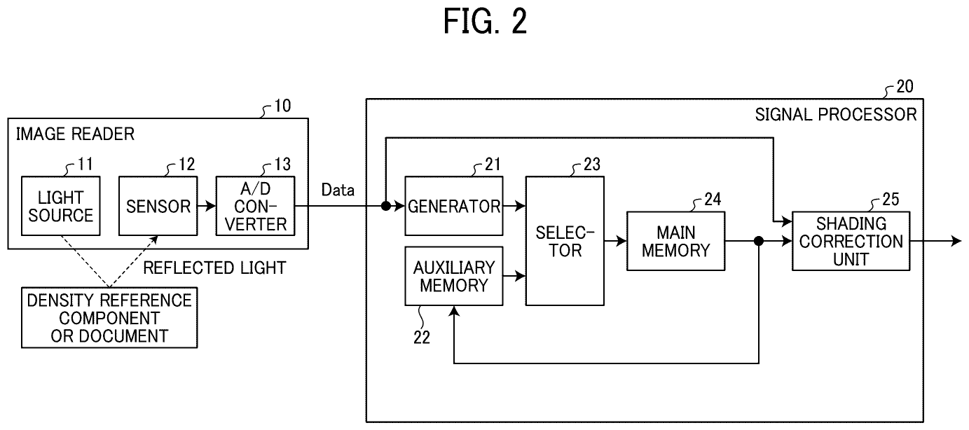

FIG. 2 is a diagram of a functional configuration related to read signal processing according to the second embodiment. The image reader 10 according to the first embodiment includes a light source 11, a sensor 12, and an A/D converter 13.

The light source 11 emits light to a document, and the sensor 12 reads an image by receiving the condensed light reflected from the document. Specifically, the sensor 12 may be a contact image sensor (CIS) using a CMOS sensor, or may be a charge coupled device (CCD) sensor.

The A/D converter 13 converts electric signals input from the sensor 12 into digital signals.

The A/D converter 13 converts analog data acquired by the sensor 12 into digital data and sends the digital data to a signal processor 20.

The data sent to the signal processor 20 includes white shading data obtained by the image reader 10's reading a density reference plate facing the image reader 10 and image data obtained by the image reader 10's reading the document. The white shading data is data used for the shading correction processing.

The image data is data used for the image forming processing of a document.

The signal processor 20 includes a generator 21, an auxiliary memory 22, a selector 23, a main memory 24, and a shading correction unit 25. The selector 23 selects data from either the generator 21 or the auxiliary memory 22 and inputs it to the main memory 24.

Each function of the signal processor 20 is implemented by the engine controller 930 or the controller 910 of the image forming apparatus that serves as an image reading device of FIG. 1.

First, the process flow from when the white shading data read from the density reference plate is stored in the auxiliary memory 22 as clean white reference data, which is an example of reference data. For the density reference plate, any color other than white may be used as the reference data.

First, the generator 21 receives white shading data from the image reader 10. The generator 21 extracts the white shading data using a sub-scanning gate signal and generates one line of white data.

When the white data is used as future white reference data, the white data passes through the selector 23 as is and is stored in the main memory 24. Thereafter, the white reference data is stored in the nonvolatile auxiliary memory 22.

Since the main memory 24 is volatile, the white reference data is lost when the power is turned off. However, the auxiliary memory 2 is non-volatile, so the white reference data is retained even if the power is turned off. The white reference data in the auxiliary memory 22 is immediately transferred to the main memory 24 through the selector 23 as soon as power is supplied, so that it can be used for the shading correction next time.

When an image is read, image data is input to the shading correction unit 25, and the white reference data stored in the main memory 24 is also input to the shading correction unit 25. The shading correction unit 25 performs the shading correction using the image data and the white reference data.

Since the read image data is also affected by the inherent characteristics of, for example, a sensor and the surrounding environment, and even if an image with uniform density is read, the image data does not remain uniform in the main scanning direction. To address this, the shading correction enables the output of an image with uniform density as uniform data.

With the functional configuration of FIG. 2, the white reference data read from the density reference plate is stored in the auxiliary memory 22 (or a nonvolatile memory). The shading correction can be performed on the image data read from the document with the white reference data stored in advance.

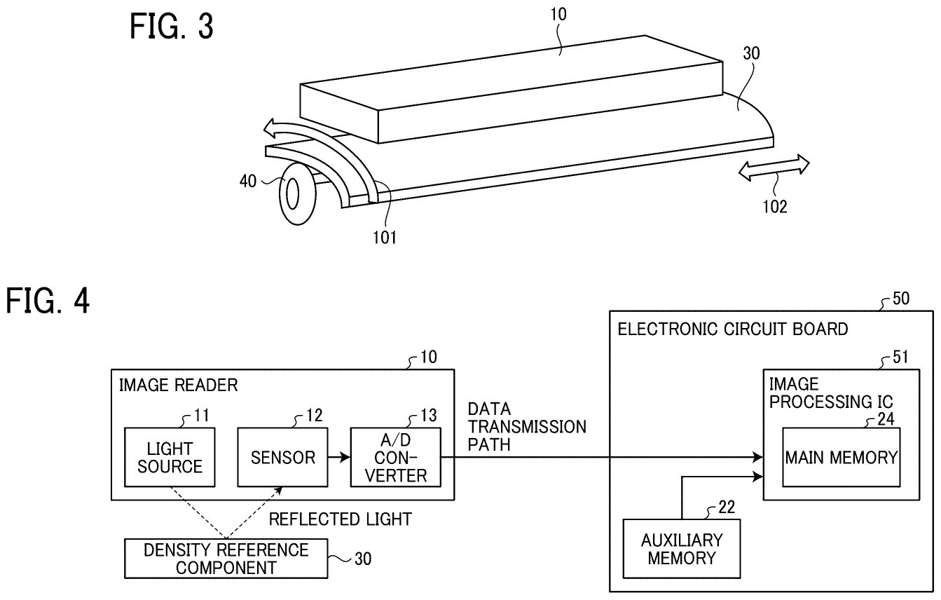

FIG. 3 is a diagram illustrating a density reference member 30 and a lock mechanism 40 according to the first embodiment. In FIG. 3, the density reference member 30 is a density reference plate positioned to face the image reader 10.

The image reader 10 includes the light source 11 and the sensor 12 described above, and reads light reflected from the density reference member 30.

The lock mechanism 40 allows a selection between a movable state in which the density reference member 30 is movable and a fixed state in which the density reference member 30 is secured.

When reading a document, the density reference member 30 is used in a fixed state. The density reference member 30 serves as a guide for document conveyance and as a background when reading a document.

When the white reference data is acquired during the shipping process in a factory or when the white reference data needs to be acquired again due to replacement of parts in the market, the lock mechanism 40 is released, and the density reference member 30 is set to the movable state.

After that, the density reference member 30 in the movable state is moved to a position not used during typical document reading, and is read as white shading data by the image reader 10. Then, the white reference data generated from the white shading data by the generator 21 is stored in the auxiliary memory 22.

At this time, the white reference data may be generated from a single line of data or from multiple lines of data, including before and after the movement of the density reference member 30.

As illustrated in FIG. 3, moving the density reference member 30 to a reading position different from the typical reading position removes the effects of dust and scratches on its surface, allowing for the generation of clean white reference data. In other words, the generator 21 generates reference data for shading correction from shading data read from the density reference member 30, which has been moved to a reading position different from the one used during document reading.

The different reading position is at least offset from the width of one line formed by sequential beam diameters emitted from one of multiple light emitters of the light source 11 to the density reference member 30. The different reading position is preferably offset from an illumination range, including the areas corresponding to the beam diameters before and after one light emitter. The density reference member 30 used at the reading position during document reading is unlocked and set to the movable state, allowing it to move freely. The density reference member 30 can then be fixed in place by the lock mechanism 40 at multiple positions different from reading position used during the document reading. The density reference member 30 can generate reference data in this fixed state.

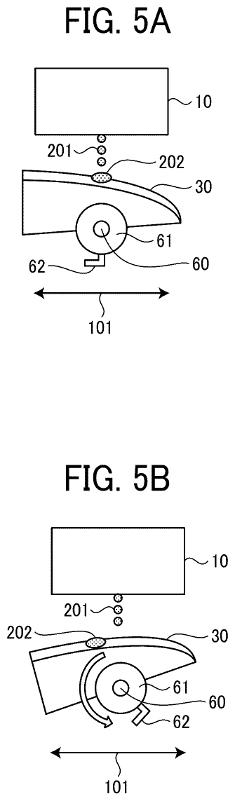

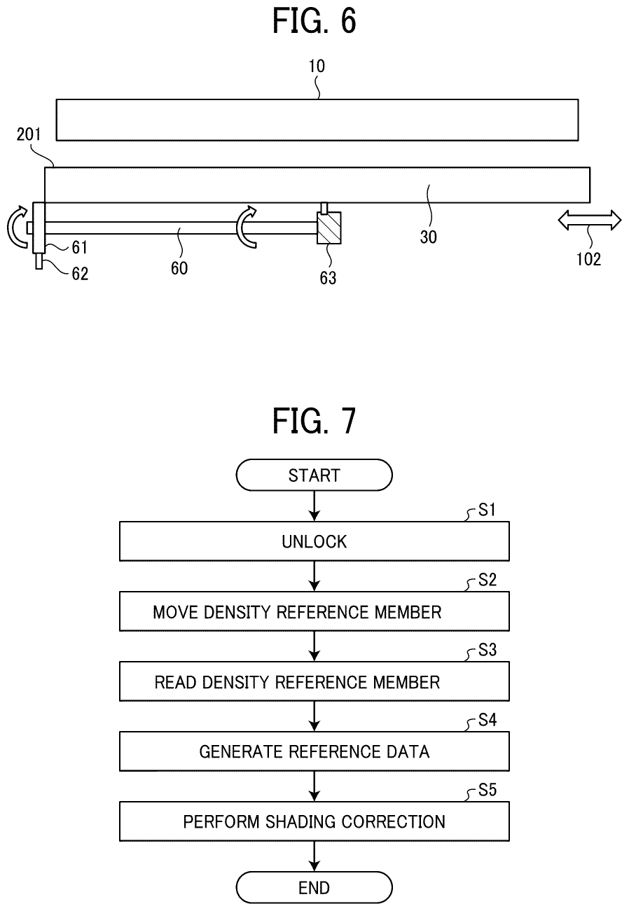

The density reference member 30 moves in the sub-scanning direction 101 and the main scanning direction 102. A movable mechanism that allows the movement of the density reference member 30 in the sub-scanning direction 101 will be described later with reference to FIGS. 5A and 5B. A movable mechanism that allows the movement of the density reference member 30 in the main scanning direction 102 will be described later with reference to FIG. 6.

FIG. 4 is a diagram illustrating a configuration of components for image reading processing according to the first embodiment. As illustrated in FIG. 4, the image reader 10 as a first component, the density reference member 30 as a second component, and an electric circuit board 50 as a third component are configured as independent components. The electric circuit board 50 is connected to the image reader 10 via a data transmission path.

When any of the image reader 10, the density reference member 30, and the electric circuit board 50 is damaged or broken, the damaged or broken component can be replaced in the market.

The white reference data stored in the auxiliary memory 22 has a different distribution depending on the combination of the light source 11 and the sensor 12 of the image reader 10, as well as the density reference member 30.

This means that when either the image reader 10 or the density reference member 30 is replaced, the consistency with the white reference data stored in the auxiliary memory 22 will be lost.

Consequently, the image reader 10, the density reference member 30, and the electric circuit board 50 are to be replaced as a set, resulting in higher parts replacement costs in the market. Even when the electric circuit board 50 is replaced, the white reference data stored in the auxiliary memory 22 is lost. This causes the need to incur the cost of making a memory that implements the auxiliary memory 22 removable.

However, using the lock mechanism 40 that allows selection between the movable state and fixed state as illustrated in FIG. 3 enables the generation of clean white reference data in the market even when any part is replaced. This reduces parts replacement costs in the market.

In other words, when any one of the above-described first component to the third component is replaced, the generator 21 regenerates reference data for shading correction from shading data read from the density reference member 30, which has been moved to a reading position different from the one used during document reading. The auxiliary memory 22 stores the reference data regenerated by the generator 21.

The auxiliary memory 22 and the main memory 24 may be placed inside or outside the image processing integrated circuit (IC) 51. In FIG. 4, the main memory 24 is inside the image processing IC 51, and the auxiliary memory 22 is outside the image processing IC 51.

If necessary, the unit of replacement in the market may be a set of the image reader 10, the density reference member 30, and the electric circuit board 50, instead of each of the image reader 10, the density reference member 30, and the electric circuit board 50.

FIG. 5A is a diagram of the movable mechanism, or the fixed state, to move the density reference member 30 in the sub-scanning direction 101 according to the first embodiment. FIG. 5A is a view of the image reader 10 and the density reference member 30 as viewed from its short side.

The density reference member 30 is positioned to face the image reader 10, and a shaft 60 and a bearing 61 are placed at a position accessible by a user. The density reference member 30 is designed to operate in conjunction with the rotation of the shaft 60 and the bearing 61 integrated with the shaft 60. In FIG. 5A, the density reference member 30 is designed to rotate. In some examples, the density reference member 30 may slide and move in the horizontal direction. The mechanism for moving the density reference member 30 in the sub-scanning direction 101 is not limited to that of FIG. 5A.

During the typical use, when the document is being read, the shaft 60 remains fixed, so the density reference member 30 does not move. When the document is being read, the reading by reflection light 201 takes place at a reading position 202 on the reading surface.

The lock mechanism that fixes the density reference member 30 in place in FIG. 5A includes a handle 62 as an operation member on the bearing 61. The handle 62 moves and hooks onto the exterior around the density reference member 30 to fix the density reference member 30 in place. Alternatively, the rotation of the density reference member 30 may be fixed by moving the handle 62 and using the tension of a spring. The mechanism for the fixed state is not limited to the example of FIG. 5A.

FIG. 5B is a diagram of the movable mechanism, or the movable state, to move the density reference member 30 in the sub-scanning direction 101 according to the first embodiment.

When the fixed state is released, the density reference member 30 becomes movable in the sub-scanning direction 101 relative to the reading direction. Then, another reading point other than the reading position 202 can be used by the reflection light 201, effectively removing dust or scratches that occur during the generation of the white reference data, particularly those extending in the main scanning direction 102.

The rotation of the shaft 60 and the release of the fixed state are performed by the operation of the user. When the operation is performed by the user, the user grips the handle 62 with fingers and rotates the handle 62 in a direction to detach it from the exterior.

An electric drive circuit may be used as a power source. When an electric drive circuit is used, a gear is added to the bearing 61, and motor power is transmitted to enable operation.

When the operation is performed by the user, the number of parts can be reduced, including the driving mechanism such as a gear for transmitting motor power and a shaft for supporting the gear, as well as the electric drive circuit. Thus, cost reduction is achieved.

FIG. 6 is a diagram of the movable mechanism to move the density reference member 30 in the main scanning direction 102 according to the first embodiment. FIG. 6 is a view of the image reader 10 and the density reference member 30 as viewed from its long side.

The density reference member 30 is positioned to face the image reader 10, and a shaft 60 and a bearing 61 are placed at a position accessible by a user. The density reference member 30 is designed to operate in conjunction with the rotation of the shaft 60 and the bearing 61. In FIG. 6, a cylindrical groove cam 63 is coupled to the density reference member 30. However, in some examples, another mechanism is used to achieve sliding movement. The mechanism for moving the density reference member 30 in the main scanning direction 102 is not limited to that of FIG. 6.

During the typical use, when the document is being read, the shaft 60 remains fixed by the lock mechanism, so the density reference member 30 does not move without the rotation of the shaft 60. The lock mechanism for fixing the shaft 60 may be configured such that the bearing 61 provided with the handle 62 rotates together with the shaft 60 and hooks onto the exterior, or may be configured to fix the rotation using the tension of a spring.

When the fixed state is released, the shaft 60 rotates, the cylindrical groove cam 63 can rotate, and the density reference member 30 can move in the main scanning direction 102 with respect to the reading direction. This allows the use of a different reading position than the one used on the reading surface for document reading. This is effective in eliminating the impact of dust or scratches that occur during the generation of the white reference data, particularly those extending in the sub-scanning direction 101.

The rotation of the shaft 60 and the release of the fixed state may be performed by using an electric drive circuit or by the operation of the user. When an electric drive circuit is used, a gear is added to the bearing 61, and motor power is transmitted to enable operation. When the operation is performed by the user, the user grips the handle 62 with fingers and rotates the handle 62. When the operation is performed by the user, the number of parts can be reduced, including a gear for transmitting motor power and a shaft for supporting the gear, as well as the electric drive circuit. Thus, cost reduction is achieved.

### Image Reading Method

FIG. 7 is a flowchart of an image reading method according to the first embodiment of the present disclosure. In step S1, the lock mechanism 40 switches the density reference member 30 positioned to face the image reader 10 from the fixed state to the movable state.

In step S2, the movable mechanism moves the density reference member 30 to a reading position different from a reading position used during document reading. For example, in FIGS. 5A and 5B, the shaft 60, the bearing 61, and the handle 62 serve as the movable mechanism that moves the density reference member 30 in the sub-scanning direction 101. For another example, in FIG. 6, the shaft 60, the bearing 61, the handle 62, and the cylindrical groove cam 63 serve as the movable mechanism that moves the density reference member 30 in the main scanning direction 102.

In some examples, the movable mechanism may have both the configurations illustrated in FIG. 5B and FIG. 6 so as to allow the movement of the density reference member 30 in both the sub-scanning direction 101 and the main scanning direction 102. In other examples, the movable mechanism may have the configuration of either FIG. 5B or FIG. 6 to allow the density reference member 30 to move in either the sub-scanning direction 101 or the main scanning direction 102.

In step S3, the image reader 10 reads shading data from the density reference member 30 in the fixed state, which has been moved to the different reading position by the processing in step S2.

In step S4, the generator 21 generates the reference date for the shading correction from the shading data read from the density reference member 30.

In step S5, the shading correction unit 25 performs shading correction on the image data read from the document using the reference data generated in step S4.

As described above, according to the first embodiment, clean reference data can be generated more easily. Specifically, in the first embodiment, the lock mechanism 40 is used to enable the density reference member 30 (for example, a white plate) used as the density reference to be selectively movable or fixed. This enables easy generation of clean white reference data while reducing the impact of dust caused by the movement of the density reference member 30 and maintaining low cost due to the fixed density reference member 30, even when parts are replaced in the market.

When the reference data is regenerated outside the manufacturing environment, eliminating the impact of dust in uncontrolled environments is extremely difficult. According to the first embodiment, the reference data with the impact of dust or scratches eliminated can be more easily recreated even when parts are replaced in the market. This can reduce the replacement cost in the market.

### Second Embodiment

The second embodiment will be described. For the second embodiment, the description of the same configurations as in the first embodiment will be omitted, and those different from the first embodiment will be described below.

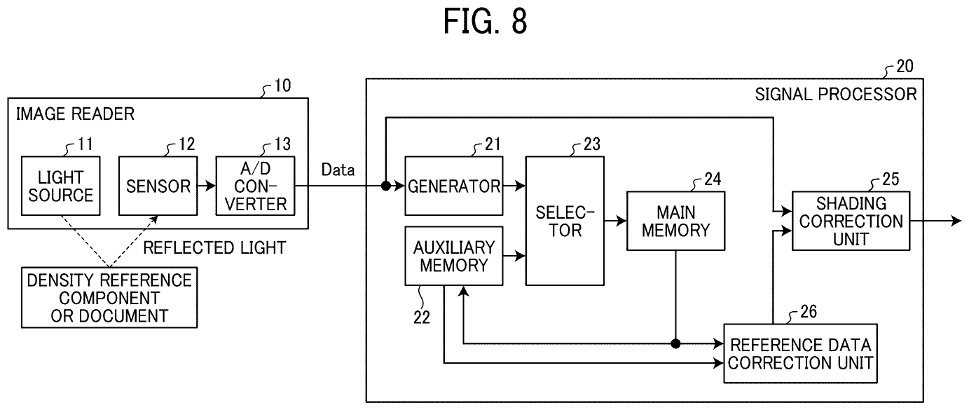

FIG. 8 is a diagram of a functional configuration related to read signal processing according to the second embodiment. In the second embodiment, the signal processor 20 further incudes a reference data correction unit 26. The reference data correction unit 26 detects an abnormal portion of the reference data recorded in the main memory 24 using the reference data stored in the auxiliary memory 22, and corrects the reference data recorded in the main memory 24.

The flow of the process of storing clean white reference data in the nonvolatile auxiliary memory 22 is the same as that in the first embodiment. The flow of processing of the second embodiment will be described below.

In the second embodiment, the image reader 10 sends white shading data obtained by reading the density reference member 30 to the generator 21, immediately before reading the image data of the document. The generator 21 generates, for example, white data for one line from the white shading data. The white data generated by the generator 21 is stored as white reference data in the main memory 24 through the selector 23.

Since the white data is obtained by reading the density reference member 30 in the fixed state, and may be influenced by dust, the white data is input to the reference data correction unit 26.

Further, clean white reference data is input from the nonvolatile auxiliary memory 22 to the reference data correction unit 26.

The reference data correction unit 26 compares two white reference data input from the main memory 24 and the auxiliary memory 22, and detects the position of dust adhering to the white data acquired immediately before the document reading. The reference data correction unit 26 performs a process of correcting the white reference data input from the main memory 24 by partially replacing the detected portion with clean white reference data. The shading correction unit 25 performs shading correction on the image data read from the document using the white reference data corrected by the reference data correction unit 26.

The light source of the image reader 10 may degrade in light amount (or intensity) due to use over time. Further, due to heat generated during operation, the sensitivity of the sensor 12 may decrease, and variations in the main scanning distribution may occur. If the white reference data stored in the auxiliary memory 22 is temporally old compared to the document reading time, it may be affected by the aforementioned variations and appear as unevenness in the data after shading correction.

However, as in the second embodiment, if the white data acquired immediately before reading the document is used, the influence of the variation due to the use over time can be absorbed. However, since the white data obtained immediately before reading the document may be affected by dust as described above, only the portion is replaced with clean white reference data in the second embodiment.

In the first embodiment, the white reference data stored in the auxiliary memory 22 is stored in the main memory 24, and the white reference data is used for shading correction as it is. In the second embodiment, the reference data correction unit 26 is used to allow most of the white reference data to be generated from the white shading data acquired immediately before reading the document.

As a result, the impact of short-term fluctuations in the light source 11 and temperature variations, which cause changes in the white shading data over time, can be mitigated. This can improve the image quality after shading correction.

Aspects of the present disclosure are as follows, for example.

### Aspect 1

An image reading device includes an image reader to read image data; a density reference member placed to face the image reader; a movable mechanism to move the density reference member; a lock mechanism to switch the density reference member to a fixed state or a movable state; a generator to generate reference data for shading correction from shading data read from a density reference member in a fixed state moved to a reading position different from a reading position used when reading a document by the movable mechanism; and a shading correction unit configured to perform shading correction on the image data using the reference data; and

### Aspect 2

The image reading device according to Aspect 1, further includes an auxiliary memory that stores the reference data; a selector to select the reference data generated by the generator or the reference data stored in the auxiliary memory; and a main memory that stores the reference data selected by the selector. The shading correction unit performs shading correction on the image data using the reference data stored in the main memory.

### Aspect 3

The image reading device according to Aspect 2
a data correction unit configured to detect an abnormal portion in the reference data recorded in the main memory by using the reference data stored in the auxiliary memory and correct the reference data recorded in the main memory.

### Aspect 4

In the image reading device according to Aspect 2, the image reader is configured as a first component, the density reference member is configured as a second component, and the main memory and the auxiliary memory are configured as a third component. When at least one of the first to third components is replaced, the generator regenerates reference data for shading correction from the shading data read from a density reference member in a fixed state moved by the movable mechanism to a reading position different from a reading position used when reading a document. The auxiliary memory stores the reference data regenerated by the generator.

### Aspect 5

In the image reading device according to any one of Aspect 1 to Aspect 4, the movable mechanism includes an operation member. The lock mechanism switches the density reference member to the fixed state or the movable state by movement of the operation member.

### Aspect 6

In the image reading device according to any one of Aspect 1 to Aspect 4, the movable mechanism moves the density reference member in the main scanning direction.

### Aspect 7

In the image reading apparatus according to any one of Aspect 1 to Aspect 4, the movable mechanism is a mechanism that moves the density reference member in the sub-scanning direction.

### Aspect 8

An image forming apparatus includes the image reading apparatus according to any one of Aspect 1 to Aspect 4; and an image former to form an image based on the image data read by the image reading device.

### Aspect 9

An image reading method includes switching, by a lock mechanism, a density reference member placed to face an image reader from a fixed state to a movable state; moving the density reference member to a reading position different from a reading position used when reading a document by a movable mechanism; reading shading data from the density reference member moved to the different reading position by an image reader; generating reference data for shading correction from shading data read from the density reference member; performing, by a shading correction unit, shading correction on the image data read from a document by using the reference data.

### Aspect 10

An image reading device includes an image reader to read image data from a document; a density reference member facing the image reader; a movable mechanism to movably support the density reference member in a movable state; a lock mechanism to lock the movable mechanism to fix a position of the density reference member in a fixed state; and circuitry configured to: cause the image reader to read the image data from the document while the density reference member is at a first position in the fixed state; cause the image reader to read shading data from the density reference member while the density reference member is at a second position different from the first position in the movable state; generate reference data used for a shading correction from the shading data read from the density reference member by the image reader; and perform the shading correction on the image data read from the document by the image reader, using the reference data.

### Aspect 11

The image reading device according to Aspect 1, further includes a first memory including nonvolatile memory; and a second memory including volatile memory. The circuitry is further configured to: generate first reference data from the shading data read and store the first reference data in the first memory via the second memory; generate second reference data from the shading data read after a generation of the first reference data; select one of the first reference data in the first memory or the second reference data and cause the second memory to store selected one of the first reference data or the second reference data; and perform the shading correction on the image data using the first reference data or the second reference data selected and stored in the second memory.

### Aspect 12

The image reading device according to Aspect 2, the circuitry is further configured to detect and correct an abnormal portion of the first reference data or the second reference data stored in the second memory using the second reference data stored in the first memory.

### Aspect 13

The image reading device according to Aspect 2, the image reader includes a first component; the density reference member includes a second component; the first memory and the second memory include a third component. When at least one of the first component, the second component, or the third component is replaced, the circuitry is further configured to regenerate reference data for shading correction, from the shading data read by the image reader from the density reference member at the second position and in the fixed state. The first memory stores the reference data regenerated.

### Aspect 14

The image reading device according to Aspect 1, the movable mechanism includes an operation member. The operation member is movable between the first position and the second position to cause the lock mechanism to lock the density reference member at the first position in the fixed state; and unlock the density reference member at the second position in the movable state.

### Aspect 15

The image reading device according to Aspect 1, the movable mechanism movably supports the density reference member in a main scanning direction in which the image reader reads the document.

### Aspect 16

The image reading device according to Aspect 1, the movable mechanism movably supports the density reference member in a sub-scanning direction in which the document is conveyed to the image reader.

### Aspect 17

An image forming apparatus includes the image reading device according to Aspect 1; and an image former to form an image read by the image reading device.

### Aspect 18

An image reading method includes reading image data from a document while a density reference member is at a first position; unlocking the density reference member facing an image reader to be movable; moving the density reference member from the first position to a second position different from the first position; reading shading data from the density reference member at the second position; generating reference data used for shading correction from the shading data read from the density reference member; and performing the shading correction on the image data read from the document, using the reference data generated from the shading data.

### Aspect 19

The image reading method according to Aspect 18, further includes: generating first reference data from the shading data read and storing the first reference data in a first memory including volatile memory via a second memory including volatile memory; generating second reference data from the shading data read after a generation of the first reference data; selecting one of the first reference data in the first memory or the second reference data and cause the second memory to store selected one of the first reference data or the second reference data; and performing the shading correction on the image data using the first reference data or the second reference data selected and stored in the second memory.

### Aspect 20

The image reading method according to Aspect 19, further includes detecting and correcting an abnormal portion of the first reference data or the second reference data stored in the second memory using the second reference data stored in the first memory.

### Aspect 21

The image reading method according to Aspect 19, further includes: regenerating reference data for shading correction, from the shading data read from the density reference member at the second position and in the fixed state when at least one of a first component as the density reference member; a second component as the density reference member; or a third component as the first memory and the second memory is replaced; and storing the reference data regenerated in the first memory.

### Aspect 22

The image reading method according to Aspect 18, further includes: locking the density reference member at the first position in the fixed state using an operation member movable between the first position and the second position; and unlocking the density reference member at the second position in the movable state using the operation member.

### Aspect 23

The image reading method according to Aspect 18, the moving the density reference member includes moving the density reference member in a main scanning direction in which the reading of the document is performed.

### Aspect 24

The image reading method according to Aspect 9, the moving the density reference member includes moving the density reference member in a sub-scanning direction in which the document is conveyed.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image reading device comprising:
an image reader to read image data from a document;
a density reference member facing the image reader;
a movable mechanism to movably support the density reference member in a movable state;
a lock mechanism to lock the movable mechanism to fix a position of the density reference member in a fixed state; and
circuitry configured to:
cause the image reader to read the image data from the document while the density reference member is at a first position in the fixed state;
cause the image reader to read shading data from the density reference member while the density reference member is at a second position different from the first position in the movable state;
generate reference data used for a shading correction from the shading data read from the density reference member by the image reader; and
perform the shading correction on the image data read from the document by the image reader, using the reference data.

2. The image reading device according to claim 1, further comprising:
a first memory including nonvolatile memory; and
a second memory including volatile memory,
wherein the circuitry is further configured to:
generate first reference data from the shading data read and store the first reference data in the first memory via the second memory;
generate second reference data from the shading data read after a generation of the first reference data;
select one of the first reference data in the first memory or the second reference data and cause the second memory to store selected one of the first reference data or the second reference data; and
perform the shading correction on the image data using the first reference data or the second reference data selected and stored in the second memory.

3. The image reading device according to claim 2,
wherein the circuitry is further configured to detect and correct an abnormal portion of the first reference data or the second reference data stored in the second memory using the second reference data stored in the first memory.

4. The image reading device according to claim 2,
wherein the image reader includes a first component;
the density reference member includes a second component;
the first memory and the second memory include a third component,
when at least one of the first component, the second component, or the third component is replaced, the circuitry is further configured to regenerate reference data for shading correction, from the shading data read by the image reader from the density reference member at the second position and in the fixed state, and
the first memory stores the reference data regenerated.

5. The image reading device according to claim 1,
wherein the movable mechanism includes an operation member, and
the operation member is movable between the first position and the second position to cause the lock mechanism to:
lock the density reference member at the first position in the fixed state; and
unlock the density reference member at the second position in the movable state.

6. The image reading device according to claim 1,
wherein the movable mechanism movably supports the density reference member in a main scanning direction in which the image reader reads the document.

7. The image reading device according to claim 1,
wherein the movable mechanism movably supports the density reference member in a sub-scanning direction in which the document is conveyed to the image reader.

8. An image forming apparatus comprising:
the image reading device according to claim 1; and
an image former to form an image based on the image data read by the image reading device.

9. An image reading method comprising:
reading image data from a document while a density reference member is at a first position;
unlocking the density reference member facing an image reader to be movable;
moving the density reference member from the first position to a second position different from the first position;
reading shading data from the density reference member at the second position;
generating reference data used for shading correction from the shading data read from the density reference member; and
performing the shading correction on the image data read from the document, using the reference data generated from the shading data.

10. The image reading method according to claim 9, further comprising:
generating first reference data from the shading data read and storing the first reference data in a first memory including volatile memory via a second memory including volatile memory;
generating second reference data from the shading data read after a generation of the first reference data;
selecting one of the first reference data in the first memory or the second reference data and cause the second memory to store selected one of the first reference data or the second reference data; and
performing the shading correction on the image data using the first reference data or the second reference data selected and stored in the second memory.

11. The image reading method according to claim 10, further comprising detecting and correcting an abnormal portion of the first reference data or the second reference data stored in the second memory using the second reference data stored in the first memory.

12. The image reading method according to claim 10, further comprising:
regenerating reference data for shading correction, from the shading data read from the density reference member at the second position when at least one of a first component as the density reference member; a second component as the density reference member; or a third component as the first memory and the second memory is replaced; and
storing the reference data regenerated in the first memory.

13. The image reading method according to claim 9, further comprising:
locking the density reference member at the first position using an operation member movable between the first position and the second position; and
unlocking the density reference member at the second position using the operation member.

14. The image reading method according to claim 9,
wherein the moving the density reference member includes moving the density reference member in a main scanning direction in which the reading of the document is performed.

15. The image reading method according to claim 9,
wherein the moving the density reference member includes moving the density reference member in a sub-scanning direction in which the document is conveyed.
